(19) United States
(12) Patent Application Publication
(10) Pub. No.: US 2026/0289713 A1
(43) Pub. Date: Sep. 24, 2026

(54) Lawful Non-Collapse Epistemic Architecture

(71) Applicant: Jody Rahsaan Jones, Queens, NY (US)

(72) Inventor: Jody Rahsaan Jones, Queens, NY (US)

(21) Appl. No.: 19/466,455

(22) Filed: Feb. 1, 2026

(51) Int. Cl. G06Q 50/26

(52) U.S. Cl. CPC G06Q 50/26

(57) ABSTRACT

A system and method for epistemic processing are disclosed that prevent collapse of authority across interpretive, evaluative, and operational stages. The architecture decomposes epistemic processing into distinct lifecycle stages and enforces structural invariants including one-way dependencies, non-persistence of interpretation, evaluative non-authority, explicit eligibility gating without execution, lawful silence and refusal, and deterministic behavior with explicit absence states. Interpretive and evaluative outputs remain descriptive and non-binding, while execution and inscription occur only through explicit external authority. Evaluative structures are stratified to preserve agent autonomy and world coherence. The invention protects the resulting architectural effect rather than any specific algorithm, enabling audit-safe, autonomy-preserving epistemic processing across diverse application domains.

### 1. TECHNICAL FIELD

The present invention relates to computational system architectures for the structured handling of epistemic information across multi-stage processing lifecycles. More specifically, the invention concerns architecture-level mechanisms that enforce non-collapse between existence, access, encounter, interpretation, coherence analysis, evaluation, eligibility determination, and action, within systems that process communicative, informational, or relational inputs.

The invention applies to systems in which information is progressively transformed, analyzed, or inspected across multiple functional stages, including but not limited to: natural-language interpretation systems, multi-agent coordination frameworks, decision-support systems, alignment and safety architectures, audit and governance infrastructures, and computational platforms that must preserve autonomy, neutrality, and accountability while operating over subjective or agent-relative information.

Unlike component-level techniques that address isolated functions such as interpretation, evaluation, prediction, or decision-making, the present invention addresses the architectural problem of authority collapse—namely, the unintended acquisition of authoritative power by analytical or evaluative subsystems as information traverses a processing pipeline. The invention provides a system-level architectural framework that constrains how epistemic information may be represented, transformed, inspected, and staged, without permitting any intermediate layer to silently assume authority over persistence, obligation, or outcome.

The technical field therefore encompasses:
non-authoritative interpretive architectures,
autonomy-preserving evaluation frameworks,
multi-layer epistemic processing systems,
audit-safe and deterministic computational pipelines, and
structural methods for preventing interpretive, evaluative, or temporal analysis from collapsing into decision or enforcement.

The invention is not limited to any particular application domain, data modality, or algorithmic technique. It instead defines architectural invariants and structural separations that may be applied across diverse computational systems wherever epistemic processing must remain lawful, non-coercive, and explicitly bounded in authority.

### 2. BACKGROUND AND ARCHITECTURAL PROBLEM

### 2.1 Collapse of Authority Across Epistemic Lifecycles

Computational systems that process communicative or epistemic material commonly operate across multiple stages, including representation, interpretation, analysis, evaluation, and downstream action. In practice, these stages are frequently implemented as layered pipelines. However, absent explicit architectural constraints, authority over outcomes tends to collapse implicitly as information traverses the pipeline.

This collapse occurs when intermediate stages—such as interpretation engines, coherence analyzers, evaluative scorers, or temporal reasoning modules—are permitted to influence persistence, obligation, or action without an explicit, bounded transition. In such systems, analytical outputs begin to function as de facto decisions, evaluative assessments are treated as commitments, and interpretive structures harden into authoritative facts. The resulting behavior is not the product of a single design choice but of cumulative, ungoverned interactions across stages.

The problem is architectural rather than algorithmic. Even systems that explicitly disclaim decision-making authority may nevertheless exert it indirectly when intermediate representations are reused, cached, propagated, or treated as defaults by downstream components. Without structural separation, authority emerges silently, making it impossible to determine which stage is responsible for a given outcome, or to audit whether autonomy, neutrality, or non-coercion has been preserved.

### 2.2 Inadequacy of Component-Level Separation

Many existing systems attempt to address authority concerns by isolating functionality at the component level—for example, separating an “analysis module” from a “decision module,” or an “evaluation layer” from an “execution layer.” While such separations may improve modularity, they are insufficient to prevent authority collapse.

Component-level separation fails because authority does not reside in components themselves but in how outputs are allowed to propagate and harden across system boundaries. An evaluative component that produces a score, label, or classification may be formally non-authoritative, yet its output may still constrain downstream behavior if consumed without an explicit eligibility gate. Similarly, an interpretive module may be framed as descriptive, but if its outputs are persisted or reused as canonical inputs, interpretation becomes indistinguishable from assertion.

Without architecture-level invariants governing persistence, feedback, eligibility, and inscription, component boundaries are porous. Authority migrates through shared data structures, implicit defaults, cached results, or optimization shortcuts. As a result, systems that appear well-factored at the component level nevertheless exhibit implicit coercion, silent normalization, and untraceable decision points.

### 2.3 Failure Modes in Existing Multi-layer Systems

The absence of explicit non-collapse architecture gives rise to recurrent failure modes across a wide range of computational systems, including:
Interpretive Hardening: interpretive or analytical outputs are stored, reused, or treated as facts, collapsing interpretation into existence.
Evaluative Overreach: evaluative assessments implicitly determine outcomes by constraining what downstream systems may consider, without an explicit eligibility transition.
Temporal Coercion: temporal reasoning or pressure staging is treated as obligation or urgency, collapsing time structure into mandate.
Feedback Contamination: downstream evaluations influence upstream representations through learning, caching, or adaptive control, erasing provenance and auditability.
Silence Erasure: absence of information is converted into negative assertion or default classification, eliminating lawful refusal or non-action.
Partial Compliance Illusions: systems implement selected safeguards (e.g., interpretability or explainability) while still allowing authority to collapse through unprotected pathways.

These failure modes are not correctable through improved models, better heuristics, or stricter policies alone. They arise from a lack of system-level constraints on how epistemic authority may move, transform, or crystallize across stages. Addressing them requires an architectural invention that defines, enforces, and preserves lawful separation across the entire epistemic lifecycle, independent of implementation details.

### 3. OVERVIEW OF THE INVENTION

The architectural constraints described herein are enforced through machine-implemented structural boundaries, immutable record planes, and one-way dependency rules, rather than through human judgment or discretionary decision logic.

### 3.1 Architectural Purpose

The purpose of the present invention is to provide a system-level epistemic architecture that preserves lawful separation between distinct stages of epistemic processing, such that no stage may silently assume authority beyond its defined role. The invention is directed at architectures in which information is progressively handled through multiple functional phases—such as interpretation, coherence analysis, evaluation, eligibility determination, and action—while maintaining explicit control over how and when authority is permitted to transition.

The invention does not seek to improve the accuracy, efficiency, or expressiveness of any individual processing stage. Instead, it defines an architectural framework in which the movement of epistemic authority itself is regulated, ensuring that descriptive, analytic, or evaluative operations cannot implicitly determine persistence, obligation, or outcome. By constraining how structure is admitted, transformed, staged, and acted upon, the architecture preserves autonomy, neutrality, and auditability across the full epistemic lifecycle.

In this way, the invention addresses a foundational systems problem: enabling rich epistemic processing without permitting interpretation, evaluation, or analysis to become coercive, decision-bearing, or outcome-determinative by default.

### 3.2 Core Non-Collapse Principle

At the center of the invention is a non-collapse principle, which states that epistemic authority must not emerge implicitly through the composition of system stages. Each stage in the epistemic lifecycle is treated as structurally distinct, with clearly bounded responsibilities and explicitly defined transition conditions.

Under this principle:
Interpretation does not create existence.
Evaluation does not create obligation.
Coherence analysis does not restrict access.
Temporal structure does not impose urgency.
Observation does not entail enforcement.

Authority may advance only through explicit, declared gates that are architecturally defined and auditable. No stage is permitted to infer, assume, or inherit authority based solely on the presence, absence, or form of upstream outputs. Conversely, downstream stages may not feed back into upstream representations in a way that alters their meaning, scope, or provenance.

The non-collapse principle is enforced not by policy or convention, but by structural design: one-way dependencies, refusal-preserving representations, explicit absence states, and prohibition of silent feedback. Together, these constraints ensure that epistemic power cannot arise as a side effect of computation.

### 3.3 Scope of Architectural Protection

The invention claims protection over the architectural effects and invariants that prevent collapse of epistemic authority, rather than over any specific algorithm, data structure, or implementation technique. The scope of protection encompasses systems that:
Decompose epistemic processing into distinct lifecycle stages;
Enforce non-authoritative interpretation, analysis, and evaluation;
Preserve silence, refusal, and non-inscription as lawful outcomes;
Separate eligibility determination from execution or action;
Maintain determinism and auditability across partial or absent computation; and
Prevent feedback that would allow downstream evaluation to modify upstream representation.

The architectural protection applies regardless of the domain in which the system operates, including linguistic, relational, temporal, informational, or multi-agent contexts. It is likewise independent of whether the system is implemented using symbolic logic, statistical models, machine learning techniques, rule-based engines, or hybrid approaches.

By claiming the structural relationships and constraints that govern how epistemic authority may lawfully move—or be prevented from moving—through a system, the invention protects against partial compliance, selective implementation, or optimization-based shortcuts that would otherwise recreate the same authority-collapse behaviors under different technical guises.

### 4. EPISTEMIC LIFECYCLE DECOMPOSITION

### 4.1 Existence

Existence refers to the structural determination that a record, artifact, or state exists within the system's canonical domain. Existence is a world-level property, not an epistemic judgment. It establishes that something is present in the system's authoritative record space, independent of whether it is accessed, encountered, interpreted, or evaluated by any agent or subsystem.

Under the invention, existence is granted only through explicit inscription mechanisms governed by architectural authority. No interpretive, analytic, or evaluative process may create existence implicitly. Outputs of computation, observation, or analysis do not exist canonically unless they pass through a declared inscription boundary. This separation ensures that interpretation cannot harden into fact and that analytic artifacts do not become authoritative by reuse or persistence.

### 4.2 Access

Access defines which canonically existing structures are eligible to be made available to a given agent or subsystem at a given present context. Access is structurally constrained and agent-relative. It is not a statement about knowledge, belief, awareness, or relevance, but a determination of lawful encounterability.

The architecture requires that access be computed independently of interpretation, coherence, or evaluation. Structures may exist without being accessible, and accessibility may vary across agents or contexts without fragmenting existence. By separating access from existence, the system prevents omniscience and ensures that asymmetric or non-transitive availability can be represented without inference.

### 4.3 Encounter

Encounter records the fact that an agent or subsystem was presented with a set of accessible structures at a given present moment. Encounter is neither belief nor memory; it is a structural event indicating exposure.

The invention treats encounter as a distinct lifecycle stage that must be explicitly resolved and, where required, persisted. Encounter is derived from the conjunction of access and routing, not inferred retroactively from existence or recomputed from current policy. Persisting encounter as its own fact prevents both omniscience substitution and retroactive reconstruction, and enables lawful reasoning about exposure without modeling cognition or uptake.

### 4.4 Reference

Reference enables structures to be pointed to, revisited, or discussed without asserting their truth, relevance, or interpretation. Referential capability allows the system to handle claims about time, ordering, or identity without grounding them prematurely.

Within the architecture, reference is explicitly separated from existence and interpretation. A structure may be referenced without being resolved, evaluated, or made coherent. Referential mechanisms preserve ambiguity, plurality, and competing claims by recording what was pointed to, not what was meant or decided. This prevents early commitment and allows downstream inspection or alignment without rewriting history.

### 4.5 Interpretation

Interpretation assigns structural meaning to encountered content, such as epistemic stance, temporal form, relational configuration, or predicate-world attachment. Interpretation is descriptive and classificatory; it does not assert truth, obligation, or outcome.

The invention enforces that interpretive outputs remain non-authoritative. Interpretation does not create existence, does not restrict access, and does not determine consequence. Interpretive structures are ephemeral unless explicitly passed through an inscription boundary. This preserves the ability to interpret richly while preventing interpretive collapse into assertion or enforcement.

### 4.6 Coherence

Coherence evaluates whether a set of time-indexed or structurally related artifacts is internally consistent under declared invariants. Coherence analysis is structural, not semantic or normative. It identifies contradictions, gaps, or violations of continuity without resolving them.

Under the invention, coherence evaluation is strictly non-authoritative. Coherence results may be observed, reported, or used diagnostically, but they do not modify existence, access, or encounter. Incoherent structures remain present and accessible unless excluded by separate authority. This separation ensures that coherence analysis does not become a hidden gatekeeper or censor.

### 4.7 Evaluation

Evaluation observes how interpreted and staged structures bear force within an agent-relative or contextual frame. Evaluation may assess structural influence, autonomy deformation, relational mode, or other evaluative geometries, but it does not decide action or commit outcome.

The architecture requires that evaluation remain non-binding and non-executive. Evaluative outputs describe patterns and relationships; they do not propagate effects, enforce compliance, or assert obligation. By isolating evaluation from both interpretation and action, the system enables lawful assessment without coercion.

### 4.8 Eligibility

Eligibility determines which evaluated structures are structurally admissible to participate in downstream consequence, propagation, or inscription. Eligibility is a gating function, not an evaluative one. It resolves whether something may proceed, not whether it should.

The invention separates eligibility from both evaluation and action. Eligibility rules are explicit, deterministic, and non-feedback-bearing. Structures that are ineligible remain visible and staged but do not participate. This prevents evaluative systems from silently determining outcomes and preserves auditability of why certain effects did or did not proceed.

### 4.9 Action and Inscription

Action and inscription represent the point at which epistemic processing alters system state, commits consequences, or records new canonical facts. This is the only lifecycle stage at which outcomes are enacted.

Under the invention, action and inscription are strictly downstream of eligibility and require explicit invocation. No upstream stage may trigger inscription implicitly. Non-action, deferral, and refusal are lawful outcomes and must be representable without error or negative inference. By confining authority to this final stage, the architecture ensures that all prior processing remains descriptive, optional, and reversible.

### 5. GLOBAL NON-COLLAPSE INVARIANTS

### 5.1 Interpretation-Existence Separation

The architecture enforces a strict separation between interpretation and existence. Interpretive processes may classify, structure, or characterize encountered material, but they are not permitted to grant canonical existence to any artifact, state, or conclusion.

Under this invariant, interpretive outputs are treated as non-authoritative descriptors. They may be transient, optional, partial, or conflicting. No interpretive result may enter the system's canonical record space unless it passes through an explicit inscription boundary governed by world-level authority. The absence of such inscription preserves the distinction between “this was interpreted” and “this exists.”

This separation prevents interpretive hardening, whereby analytic or classificatory structures silently become treated as facts through reuse, caching, or implicit persistence. Interpretation remains expressive without becoming assertive.

### 5.2 Interpretation-Evaluation Separation

Interpretation and evaluation are distinct epistemic operations and must not collapse into one another. Interpretation resolves what kind of structure is present; evaluation observes how that structure bears force within a contextual or agent-relative frame.

The invention enforces that interpretive structures do not embed evaluative meaning, weighting, or force, and that evaluative processes do not reinterpret or rewrite interpretive outputs. Evaluative systems consume interpretation as read-only structure and may project into it, but they may not modify, normalize, or privilege interpretive representations.

This invariant prevents evaluative bias from leaking backward into meaning resolution and ensures that structural description remains independent of judgment, preference, or outcome consideration.

### 5.3 Evaluation-Decision Separation

Evaluation does not constitute decision. Evaluative outputs describe relational, epistemic, or autonomy-relevant patterns, but they do not authorize action, commitment, or state change.

The architecture enforces that no evaluative result may directly trigger execution, inscription, or enforcement. All evaluative outputs are non-binding and must pass through an explicit eligibility resolution boundary before any downstream system may consider action.

By separating evaluation from decision, the invention prevents evaluative metrics, scores, or classifications from becoming de facto commands or mandates. Decisions remain externally governed, explicit, and accountable.

### 5.4 Temporal Pressure-Obligation Separation

Temporal structure may produce pressure—such as persistence, forward reach, irreversibility, or proximity—but temporal pressure does not imply obligation. Under this invariant, temporal staging systems may expose how time-indexed structures bear on the present, but they may not impose urgency, duty, or requirement. Temporal pressure is treated as a structural condition, not a normative force.

Any transformation of temporal pressure into obligation, priority, or mandate must occur outside the lawful interpretive architecture, under explicit decision authority. This separation prevents time-based coercion and preserves the agent's autonomy in responding to temporal conditions.

### 5.5 Observation-Enforcement Separation

The architecture strictly separates observation from enforcement. Systems may observe structure, coherence, evaluative geometry, or eligibility status, but observation alone does not justify intervention. Diagnostic, analytical, or coherence-related outputs are informational. They do not suppress records, block access, force resolution, or compel action. Enforcement—whether in the form of suppression, propagation, or inscription—requires an explicit, downstream authority that is not exercised by observational components.

This invariant ensures that visibility does not become control, that detection does not become punishment, and that analysis does not silently convert into governance.

### 6. STRUCTURAL PROHIBITION OF INTERPRETIVE PERSISTENCE

### 6.1 Interpretive Outputs as Non-Persistent Artifacts

Under the architecture of the present invention, all interpretive outputs are treated as non-persistent artifacts by default. Interpretation produces structural descriptions, classifications, or orientations over encountered material, but these outputs exist only within the ephemeral interpretive workspace unless explicitly admitted elsewhere.

Interpretive artifacts are permitted to be partial, sparse, conflicting, or incomplete. They may vary across contexts, agents, or evaluation moments without requiring reconciliation. The architecture does not assume that interpretive results must stabilize, converge, or resolve. Instead, interpretation is recognized as a descriptive act whose outputs are inherently provisional.

By default, interpretive artifacts:
are not written into canonical record planes,
are not reused as authoritative inputs by upstream or parallel components,
are not treated as commitments, facts, or obligations, and
may be discarded, replaced, or re-derived without side effects.

This treatment preserves interpretive freedom while preventing interpretive authority from accumulating through persistence or reuse.

### 6.2 Prohibition on Canonical Hardening

The invention explicitly prohibits canonical hardening, defined as any process by which interpretive or analytic outputs acquire authoritative status without passing through a declared inscription boundary.

Canonical hardening may occur through mechanisms such as:
automatic persistence of interpretive outputs,
reuse of interpretive artifacts as default canonical inputs,
caching of interpretive results across cycles without revalidation,
treating absence of reinterpretation as confirmation, or
collapsing interpretive descriptors into record identity.

All such mechanisms are structurally disallowed. No interpretive output—regardless of confidence, frequency, or consistency—may enter canonical existence implicitly. Repetition does not confer authority, convergence does not imply truth, and stability does not justify persistence.

This prohibition ensures that canonical state reflects only explicitly inscribed artifacts, preserving the distinction between “what was interpreted” and “what exists.”

### 6.3 Explicit Inscription Gates

The only lawful mechanism by which interpretive or analytic artifacts may acquire canonical existence is through explicit inscription gates defined by the architecture.

An inscription gate is a declared, system-level boundary that:
identifies which class of artifacts may be admitted,
records the canonical present at which admission occurs,
preserves provenance of upstream interpretive inputs,
encodes whether admission reflects creation, acknowledgment, or registration, and
prevents upstream modification or retroactive reinterpretation.

Inscription gates are authoritative but narrow. They do not reinterpret content, resolve ambiguity, or evaluate correctness. They perform only the act of admission: binding an artifact to canonical existence under explicit rules.

By requiring all persistence to pass through such gates, the architecture ensures that authority transitions are visible, auditable, and non-accidental, and that no interpretive process may silently become world-defining.

### 7. LAWFUL SILENCE, REFUSAL, AND NON-ACTION

### 7.1 Silence as a First-Class Structural State

The architecture treats silence—the absence of structure, signal, or resolution—as a first-class structural state. Silence is not an error, omission, or failure; it is a meaningful and lawful outcome of epistemic processing.

At every stage of the epistemic lifecycle, the system must be able to represent:
absence of interpretation,
absence of temporal specification,
absence of evaluative force,
absence of eligibility, and
absence of action.

Silence is represented explicitly rather than implicitly. It is not encoded as a default value, negation, or opposing pole. A silent state asserts only that no structure was licensed or produced at that stage. This design preserves neutrality and prevents the system from inventing structure where none was expressed or authorized.

By elevating silence to a first-class state, the invention ensures that epistemic processing can remain incomplete, underspecified, or intentionally withheld without being coerced into artificial completeness.

### 7.2 Refusal Without Negative Inference

The architecture supports refusal as a lawful and explicit outcome whenever a component cannot proceed without inference, heuristic completion, or authority overreach. Refusal differs from failure. Failure implies incorrect execution or violation of contract. Refusal indicates that the available inputs are insufficient to support a lawful operation under the component's constraints. Refusal therefore preserves structural integrity by declining to act rather than acting improperly.

Critically, refusal does not license negative inference. A refusal to interpret does not imply negation of meaning. A refusal to evaluate does not imply neutrality, irrelevance, or insignificance. A refusal to unify structure does not imply incoherence or contradiction. Refusal asserts only that the operation was not performed.

This invariant prevents systems from treating non-action as a weak signal, a default classification, or a probabilistic negative. It preserves epistemic humility and ensures that absence of output cannot be misread as an implicit judgment.

### 7.3 Non-Inscription as Lawful Outcome

Non-inscription—the decision not to admit an artifact into canonical existence—is a fully lawful outcome under the architecture. The system does not presume that all processing must culminate in persistence, commitment, or state change.

Many epistemic acts properly terminate without inscription, including:
exploratory interpretation,
provisional evaluation,
incoherent or underspecified structure,
deferred temporal reasoning,
withheld consequence, and
agent-side consideration without commitment.

The architecture enforces that non-inscription carries no penalty and no implied deficiency. Artifacts that are not inscribed simply do not exist canonically; they do not linger as shadow state, partial fact, or suppressed truth.

By preserving non-inscription as a valid endpoint, the invention prevents pressure toward premature commitment and ensures that epistemic authority is exercised only when explicitly invoked, rather than as a byproduct of processing.

### 8. NON-FEEDBACK ANALYTIC ARCHITECTURE

### 8.1 One-Way Dependency Constraint

The architecture enforces a one-way dependency constraint across all epistemic lifecycle stages. Information may flow forward—from existence to access, from encounter to interpretation, from evaluation to eligibility—but it may not flow backward in a manner that alters upstream structure, meaning, or authority.

Each stage consumes upstream outputs as read-only inputs and produces outputs that are valid only within its own scope. Downstream components may observe, analyze, or stage consequences of upstream structure, but they are prohibited from conditioning, revising, or reclassifying upstream representations based on downstream results.

This constraint ensures that:
interpretation does not depend on evaluation outcomes,
evaluation does not revise meaning or stance,
coherence analysis does not alter accessibility,
eligibility does not rewrite temporal or relational structure, and
action does not retroactively justify prior stages.

By enforcing strictly directional dependency, the system preserves provenance, determinism, and auditability across repeated or partial runs.

### 8.2 Prohibition on Upstream Modification

Closely related to one-way dependency is an explicit prohibition on upstream modification. No analytic, evaluative, or diagnostic component may mutate, normalize, or condition any artifact produced by an upstream stage.

This prohibition applies regardless of confidence, frequency, or apparent correctness of downstream outputs. Even when a downstream component identifies inconsistency, incoherence, or illegitimacy, it may only report that condition; it may not correct, suppress, or repair upstream structure.

Upstream modification is prohibited in all forms, including:
in-place mutation of records,
shadow updates through cached defaults,
reinterpretation via rewritten references,
conditional suppression masquerading as filtering, and
adaptive feedback that alters future upstream behavior without explicit re-inscription.

Any change to upstream structure must occur only through explicit action and inscription at the appropriate lifecycle boundary, never through analytic side effects.

### 8.3 Diagnostic Outputs as Non-Authoritative

All diagnostic outputs produced by the architecture—such as coherence classifications, violation reports, eligibility denials, or evaluative observations—are explicitly non-authoritative.

Diagnostic outputs:
describe structural properties of inputs,
preserve all referenced artifacts unchanged,
carry no enforcement power, and
do not restrict visibility, access, or participation by themselves.

Diagnostics may be consumed by inspection tools, external governance systems, or decision-making processes that explicitly assume responsibility for action. However, within the lawful interpretive architecture, diagnostic outputs remain informational only.

By treating diagnostics as non-authoritative views rather than control signals, the architecture ensures that analysis does not become governance and that observation does not silently convert into enforcement.

### 9. EVALUATION WITHOUT AUTHORITY

### 9.1 Evaluative Non-Authority Invariant

The architecture enforces an evaluative non-authority invariant, under which evaluative processes are strictly prohibited from asserting, modifying, or enforcing outcomes. Evaluation is permitted to observe, characterize, and project over structural inputs, but it is not permitted to create obligations, commitments, permissions, or prohibitions.

Evaluative outputs may condition understanding of structure, but they do not constitute authority over that structure. They do not bind agents, alter canonical state, restrict access, or mandate response. Even when evaluative outputs identify structural deformation, coercive patterns, or illegitimate relational force, those outputs remain descriptive.

This invariant ensures that evaluation remains an analytic function rather than a governing one, preserving agent autonomy and preventing evaluative layers from becoming implicit policy engines or enforcement mechanisms.

### 9.2 Distinction Between Evaluation and Effect

Evaluation and effect are structurally distinct stages of the epistemic lifecycle. Evaluation determines how structure bears within an evaluative geometry; effect concerns whether and how that bearing is allowed to participate in downstream consequence, propagation, or inscription.

Under the invention, evaluative outputs do not themselves produce effects. They may inform later stages, but they do not enact them. The presence of an evaluative signal—regardless of magnitude, direction, or consistency—does not imply that any downstream action is warranted or permitted.

This distinction prevents a common failure mode in multi-layer systems, where evaluative scores or classifications are treated as implicit triggers for response. By separating evaluation from effect, the architecture ensures that interpretive insight does not collapse into operational control.

### 9.3 Eligibility Exposure Without Execution

The architecture permits evaluative outputs to be exposed to eligibility determination without authorizing execution. Eligibility resolution answers a narrow structural question: whether a given evaluated structure may lawfully proceed to consequence consideration or inscription.

Eligibility exposure is passive and declarative. It does not execute actions, apply force, or alter state. Structures that are deemed ineligible remain visible, staged, and inspectable; they are simply withheld from participation. No suppression, erasure, or reinterpretation occurs as a result of ineligibility.

By allowing eligibility exposure without execution, the system preserves transparency and auditability while maintaining strict control over when epistemic processing may transition into action. Evaluation informs possibility; eligibility constrains admissibility; execution remains a separate, explicitly invoked authority.

### 10. EVALUATIVE STRUCTURE CLASSIFICATION

### 10.1 World-Dominated Evaluative Structures

World-dominated evaluative structures are evaluative substrates whose admissible form is constrained by world-side structure, even though their activation or manifestation may be agent-relative. These structures operate under shared authority, in which the world supplies non-negotiable boundary conditions and the agent operates within those bounds.

Such structures include, by way of example:
temporal staging mechanisms that depend on canonical time and continuity,
consequence eligibility filters that depend on coherence and admissibility constraints,
irreversibility and horizon limits imposed by world-side temporal structure.

In these cases, the architecture permits the lawful construction and mutation of evaluative representations, but only within explicitly defined structural constraints supplied by canonical state, coherence evaluation, and access rules. The agent may not override these constraints, and the evaluative system may not relax them.

World-dominated evaluative structures therefore encode what may be considered, not what must be concluded. They remain non-binding with respect to judgment and action, while remaining structurally grounded in world authority.

### 10.2 Agent-Autonomy Evaluative Structures

Agent-autonomy evaluative structures are evaluative substrates that are exclusively owned by the agent. These structures encode agent continuity, evaluative stance, relational configuration, or subjective weighting, and are not authored, imposed, or modified by the lawful interpretive system.

Examples include:
agent-held in-force carriage,
participation configuration,
internal evaluative geometry or likeness space,
private relational or normative configuration.

Under the architecture, such structures may be:
read by interpretive or evaluative systems for descriptive purposes,
referenced as boundary conditions during evaluation,
surfaced in audit traces as inputs to evaluative geometry.

However, they may not be:
written by the system,
coerced into a particular configuration,
inferred implicitly from behavior, or
retroactively modified by downstream outcomes.

This preserves agent sovereignty. The system may observe how agent-owned structure conditions evaluation, but it may not author or enforce that structure.

### 10.3 Prohibition on Cross-Category Authority Transfer

The architecture enforces a strict prohibition on cross-category authority transfer between world-dominated and agent-autonomy evaluative structures.

Specifically:
world-dominated structures may not overwrite, normalize, or dictate agent-owned evaluative configuration;
agent-owned structures may not override, bypass, or weaken world-imposed structural constraints;
evaluative outputs derived from one category may not be used to mutate structures in the other.

This prohibition prevents two symmetric failure modes:
1. World coercion, in which canonical or evaluative authority collapses agent autonomy by imposing evaluative stance or participation configuration.
2. Agent override, in which agent preference or stance is treated as sufficient to bypass structural legality, coherence, or temporal constraints.
By stratifying evaluative authority and forbidding transfer across strata, the invention preserves a lawful balance:
the world constrains what is structurally admissible,
the agent retains sovereignty over judgment, stance, and adoption,
evaluation remains descriptive and non-coercive.

This stratification is essential to ensuring that evaluative analysis informs without governing, and that autonomy is preserved without fragmenting world coherence.

### 11. ELIGIBILITY RESOLUTION BOUNDARY

### 11.1 Structural Eligibility Determination

Eligibility determination is a structural boundary operation that resolves whether a given evaluated structure may lawfully proceed to downstream consideration. It does not judge merit, desirability, correctness, or importance. It answers only whether participation is admissible under declared architectural constraints. Eligibility determination resolves structural admissibility without selection among alternatives.

Eligibility is computed using explicit, inspectable structural predicates derived from upstream stages, such as:
canonical existence and anchoring,
lawful access and encounter conditions,
coherence and continuity constraints,
explicit participation limits or horizon bounds.

Eligibility operates over already-produced structure. It does not request additional interpretation, infer missing structure, or repair insufficiencies. Where required inputs are absent, eligibility must return an explicit non-eligible or withheld state rather than inferring permissibility.

By defining eligibility as a structural gate rather than an evaluative judgment, the architecture ensures that admissibility remains rule-governed, transparent, and independent of subjective valuation.

### 11.2 Separation From Evaluation and Decision

Eligibility is strictly separated from both evaluation and decision.

Evaluation observes how structure bears within an evaluative geometry. Decision determines whether and how to act. Eligibility lies between them as a non-evaluative filter that constrains which evaluated structures may even be considered for effect.

Eligibility does not:
compute evaluative likeness,
weigh competing considerations,
prioritize outcomes,
select actions, or
imply obligation.

Conversely, evaluation does not decide eligibility, and decision does not compute it. This separation prevents evaluative signals from becoming de facto permissions and prevents decisions from retroactively redefining what was structurally admissible.

Eligibility therefore preserves a clean division of labor: evaluation informs understanding, eligibility constrains admissibility, and decision—external to the lawful interpretive architecture—remains the only stage at which choice or commitment may occur.

### 11.3 Non-Execution Guarantee

The architecture enforces a non-execution guarantee at the eligibility boundary. Eligibility determination does not execute, trigger, or authorize any action by itself. Structures deemed eligible are merely exposed as candidates for downstream consideration. Structures deemed ineligible remain intact, visible, and auditable; they are not suppressed, erased, or penalized. No state change occurs at the point of eligibility resolution.

Execution—whether in the form of propagation, inscription, enforcement, or commitment—must be invoked explicitly by an external authority that assumes responsibility for action. Eligibility neither initiates nor implies such invocation.

By guaranteeing non-execution at the eligibility stage, the invention prevents the common architectural failure in which gating logic silently becomes action logic, and ensures that admissibility never collapses into enforcement.

### 12. DETERMINISM AND AUDITABILITY

### 12.1 Deterministic Structural Resolution

All structural resolution performed within the architecture is deterministic by construction. Given identical inputs, identical versioned rules, and identical canonical anchors, every component must produce identical outputs.

Determinism applies to all stages of the epistemic lifecycle, including:
interpretation and structural mapping,
access and encounter resolution,
coherence evaluation,
temporal staging,
evaluative observation,
eligibility determination.

No component may introduce stochastic behavior, adaptive learning, probabilistic branching, or execution-order dependence. Where ambiguity exists, the system must resolve it through explicit refusal or silence rather than nondeterministic choice.

Deterministic resolution ensures that structural outcomes are attributable to declared inputs and rules, not to execution artifacts, timing, or hidden state.

### 12.2 Explicit Absence and Non-Computation States

The architecture requires that absence and non-computation be represented explicitly and distinguishably.

Components must differentiate among:
structure that is present and resolved,
structure that is absent because no expression was licensed,
structure that is absent due to refusal,
structure that is inapplicable by design,
structure that is deferred or uncomputed.

Non-computation is not treated as neutrality, default, or zero. Each non-output state is explicitly labeled so downstream components can reason about what did not occur and why, without inference.

By encoding absence explicitly, the architecture prevents silent collapse of missing data into assumed structure and preserves interpretive humility across repeated runs or partial executions.

### 12.3 Reproducible Architectural Behavior

Because the system is deterministic and explicit about absence, it is fully reproducible. Reproducibility entails that:
the same inputs yield the same outputs across runs,
intermediate states can be reconstructed or audited,
diagnostic outputs can be traced to their originating structures,
partial executions do not contaminate later results,
changes in behavior are attributable solely to versioned rule or input changes.

Every output is accompanied by sufficient provenance to support replay, inspection, and verification without reintroducing inference or interpretation.

These guarantees make the architecture suitable for safety-critical, governance, and audit-intensive domains, where trust depends not on claims of correctness, but on the ability to reproduce and explain system behavior precisely.

### 13. PARTIAL COMPLIANCE INFRINGEMENT DOCTRINE

### 13.1 Inseparability of Core Invariants

The core invariants defined by the present invention are inseparable. Each invariant—non-collapse of authority, non-persistence of interpretation, silence preservation, non-feedback analysis, evaluative non-authority, eligibility without execution, and determinism with explicit absence—depends on the others to maintain lawful operation.

No single invariant achieves the architectural effect in isolation. For example:
prohibiting interpretive persistence without enforcing non-feedback permits covert authority via adaptive correction;
enforcing evaluative non-authority without explicit eligibility boundaries permits de facto enforcement by exposure;
preserving silence without deterministic refusal semantics permits implicit defaults.

Accordingly, the invention defines a co-defining set of invariants whose combined operation yields the protected architectural behavior. Removing, weakening, or bypassing any one invariant undermines the others and reintroduces authority collapse through alternate paths.

### 13.2 Prohibition on Selective Implementation

The invention expressly prohibits selective implementation of the architectural invariants as a means to evade the protected effect. Selective implementation includes, but is not limited to:
enforcing non-persistence while allowing evaluative feedback to alter upstream behavior,
maintaining access-existence separation while allowing interpretive outputs to harden through caching,
providing eligibility determination while coupling it to automatic execution,
exposing diagnostic outputs that implicitly gate access or participation.

Implementations that reproduce the same architectural effect—namely, preventing authority collapse across the epistemic lifecycle—by distributing, renaming, or reordering components remain within the scope of the invention. The claims are directed to the structural effect and invariant relationships, not to a particular modular decomposition or naming scheme.

### 13.3 Architectural Effect as Claim Basis

The basis of the claims is the architectural effect achieved by enforcing the inseparable invariants across the epistemic lifecycle. That effect includes:
prevention of silent authority acquisition by analytic or evaluative layers,
preservation of agent autonomy in the presence of rich evaluation,
lawful handling of absence, refusal, and non-action,
audit-safe, deterministic behavior across partial and repeated execution,
explicit, gated transitions between interpretation, evaluation, eligibility, and inscription.

Any system that achieves this effect by structurally constraining authority transitions, enforcing one-way dependencies, prohibiting implicit persistence, and separating evaluation from execution falls within the scope of the claimed invention, regardless of implementation language, computational technique, or application domain.

The claims therefore protect the architecture as an indivisible system, rather than any isolated component, algorithm, or data structure, ensuring that the protected subject matter cannot be replicated through partial compliance or incremental approximation.

### 14. SYSTEM-LEVEL CONSEQUENCES

### 14.1 Preservation of Agent Autonomy

The architecture preserves agent autonomy by ensuring that no internal system process—interpretive, evaluative, temporal, or diagnostic—can unilaterally bind, coerce, or commit an agent to belief, obligation, or action. Autonomy is preserved structurally, not normatively. The system does not rely on ethical assertions or policy rules to protect the agent. Instead, it enforces hard architectural boundaries that prevent:
evaluation from becoming obligation,
temporal pressure from becoming mandate,
eligibility from becoming execution, and
observation from becoming enforcement.

By restricting authority at the architectural level, the invention ensures that agents remain the sole owners of judgment, stance, adoption, and commitment, regardless of how rich or sophisticated the system's analytical capabilities become.

### 14.2 Prevention of Coercive Architectures

The invention prevents the emergence of coercive architectures—systems in which layered analysis, scoring, prediction, or evaluation gradually accumulates de facto authority over outcomes.

In many existing systems, coercion arises unintentionally through:
feedback loops that “correct” upstream representations,
evaluative scores that implicitly trigger actions,
temporal models that convert persistence into urgency,
silence treated as non-compliance or failure.

The present architecture eliminates these failure modes by design. It enforces explicit gates, one-way dependencies, non-execution guarantees, and lawful non-action semantics that make coercion structurally impossible without explicit, external authority.

As a result, any coercive effect must be authored outside the lawful interpretive system and cannot arise accidentally from analytic complexity or system optimization.

### 14.3 Compatibility With Downstream Domains

The architecture is domain-agnostic and explicitly designed to remain compatible with a wide range of downstream systems that may assume authority, make decisions, or enforce outcomes.

Because the invention:
preserves determinism and auditability,
exposes eligibility without execution,
separates descriptive analysis from action,
and maintains explicit provenance and absence states,
   it can safely integrate with downstream domains including, but not limited to:
governance and policy enforcement systems,
human decision-support tools,
safety and alignment layers,
simulation and planning engines,
legal, contractual, or compliance frameworks.

Crucially, downstream systems may assume responsibility for action without inheriting hidden authority from the interpretive stack. This allows the invention to serve as a lawful epistemic substrate beneath systems that require control, enforcement, or optimization, without itself becoming a source of coercion or implicit governance.

### 15. CLOSING STATEMENT

The present invention defines and protects a system-level architectural framework for processing epistemic information without collapse of authority across interpretive, evaluative, temporal, and operational stages. Rather than introducing new analytical techniques, heuristics, or decision logic, the invention establishes structural invariants that govern how authority may and may not propagate within a computational system.

By enforcing non-collapse between existence, access, encounter, interpretation, coherence, evaluation, eligibility, and action, the architecture ensures that no internal analytical layer can silently acquire governing power. Interpretation remains descriptive. Evaluation remains non-binding. Eligibility constrains admissibility without execution. Silence, refusal, and non-inscription remain lawful outcomes. Action and inscription occur only through explicit, externally authorized transitions.

The invention's contribution lies in recognizing that many failures in modern computational systems—coercion, loss of autonomy, uninspectable behavior, and irreproducible outcomes—arise not from incorrect algorithms but from architectural authority leakage. By treating authority as a first-class structural concern and embedding its constraints directly into the system architecture, the invention prevents these failures by construction.

The protected subject matter is therefore not any single component, data structure, or algorithm, but the inseparable architectural effect produced by the coordinated enforcement of the defined invariants. Any system that reproduces this effect—regardless of implementation detail, domain, or computational substrate—falls within the scope of the invention.

This architecture enables powerful interpretive and evaluative systems to operate without coercion, preserves agent autonomy in the presence of complex analysis, and provides a lawful, auditable foundation upon which downstream decision-making, governance, or enforcement systems may safely be built.

1. A computer-implemented epistemic processing system comprising a plurality of distinct structural stages arranged across an epistemic lifecycle, the stages including at least existence, access, encounter, interpretation, coherence, evaluation, eligibility, and action or inscription, wherein each stage is structurally constrained such that authority associated with any downstream stage is prohibited from modifying, conditioning, or retroactively influencing any upstream stage.

2. The system of claim 1, wherein interpretive outputs generated by the interpretation stage are explicitly designated as non-persistent artifacts and are prohibited from being inscribed into canonical system state absent passage through an explicit inscription gate.

3. The system of claim 1, wherein evaluative outputs are structurally non-authoritative and are prohibited from asserting obligation, commitment, permission, prohibition, or execution.

4. The system of claim 1, wherein the eligibility stage determines admissibility of evaluated structure for downstream consideration without executing, triggering, or authorizing any action.

5. The system of claim 1, wherein silence, refusal, and non-computation are represented as explicit first-class structural states distinct from negation, failure, or default values.

6. The system of claim 1, wherein all dependencies between stages are strictly one-way such that information flows forward through the lifecycle but analytic or evaluative results are prohibited from feeding back into upstream representations.

7. The system of claim 1, wherein diagnostic outputs, including coherence assessments and violation reports, are designated as informational only and lack authority to alter access, participation, or inscription.

8. The system of claim 1, wherein determinism is enforced such that identical inputs, rule versions, and canonical anchors produce identical outputs across all stages of the lifecycle.

9. The system of claim 1, wherein absence of structure is explicitly encoded to distinguish between inapplicability, refusal, deferral, and non-execution.

10. The system of claim 1, wherein evaluative structures are stratified into world-dominated evaluative structures and agent-autonomy evaluative structures.

11. The system of claim 10, wherein world-dominated evaluative structures are constrained by canonical world-side authority and agent-autonomy evaluative structures are exclusively agent-owned and non-writable by the system.

12. The system of claim 10, wherein cross-category authority transfer between world-dominated evaluative structures and agent-autonomy evaluative structures is explicitly prohibited.

13. The system of claim 1, wherein eligibility determination is structurally separated from both evaluation and decision such that evaluative signals cannot implicitly authorize execution.

14. The system of claim 1, wherein execution, propagation, or inscription occurs only through an explicit external authority assuming responsibility for action.

15. The system of claim 1, wherein the architecture prohibits selective implementation of its structural invariants such that omission or weakening of any invariant undermines the protected architectural effect.

16. The system of claim 1, wherein the protected subject matter is defined by the architectural effect of preventing collapse of authority across the epistemic lifecycle rather than by any specific component, algorithm, or data structure.

17. A method for processing epistemic information in a multi-stage system, the method comprising enforcing non-collapse of authority between interpretive, evaluative, and operational stages such that no internal analytic process acquires execution authority.

18. The method of claim 17, wherein evaluation informs understanding without producing obligation and eligibility constrains admissibility without execution.

19. The method of claim 17, wherein silence and non-action are preserved as lawful outcomes.

20. A non-transitory computer-readable medium storing instructions that, when executed, cause a system to perform the method of any of claims 17-19.
